(19) United States
(12) Patent Application Publication
(10) Pub. No.: US 2025/0304070 A1
(43) Pub. Date: Oct. 2, 2025

(54) Method, Device, Controller, and Computer Program Product for Comfortable Braking

(71) Applicant: Robert Bosch GmbH, Stuttgart (DE)

(72) Inventor: Renrui Wang, Suzhou (CN)

(21) Appl. No.: 19/086,630

(22) Filed: Mar. 21, 2025

(30) Foreign Application Priority Data
Mar. 27, 2024 (CN) 2024 1036 4873.4

(51) Int. Cl. B60W 30/18; B60W 10/08; B60W 10/188

(52) U.S. Cl. CPC B60W 30/18127; B60W 10/08; B60W 10/188; B60W 2510/18; B60W 2520/10

(57) ABSTRACT

A method, a device, a controller, and a computer program product for comfortable braking are disclosed. The method includes (i) determining a comfortable braking force based on an openness of a brake pedal of a vehicle, (ii) obtaining a current hydraulic braking force of the vehicle, (iii) requesting a drive force from a vehicle control unit in response to the hydraulic braking force being greater than the comfortable braking force, and (iv) performing comfortable braking on the vehicle based on the hydraulic braking force and the drive force. The above method enables the realization of the comfortable braking function with the participation of hydraulic brakes, which improves the flexibility of the comfortable braking by simultaneously utilizing the hydraulic braking force and the drive force, and expands the application scene of the comfortable braking, thereby improving the ride experience of drivers and passengers.

This application claims priority under 35 U.S.C. § 119 to application no. CN 2024 1036 4873.4, filed on Mar. 27, 2024 in China, the disclosure of which is incorporated herein by reference in its entirety.

Embodiments of the present disclosure relate to the computer field, and more particularly, to a method, device, controller, and computer program product for comfortable braking.

### BACKGROUND

The comfortable braking is a function that uses an intelligent brake system to improve the comfort of rides when the vehicle brakes. It eliminates deceleration shock by controlling brake pressure, digests the energy absorbed by the suspension in advance and smooths the entire parking process. An advantage of the comfortable braking function is that it avoids forward tilting and backward rebound when the vehicle brakes, reduces discomfort of drivers and passengers, and improves user experience.

The comfortable braking is a critical part of car driving, and a good brake system ensures a smooth and fast speed down process, providing a more comfortable driving experience for drivers. The comfortable braking function effectively reduces the physical discomfort of the drivers and passengers, especially in urban traffic involving frequent starts and stops, and can effectively reduce the fatigue of the drivers and passengers. In addition, a good brake system can also improve the operation performance of the entire vehicle and make driving more stable and reliable.

### SUMMARY

Embodiments of the present disclosure provide a method, device, controller, computer program product, and media for comfortable braking.

A first aspect of the present disclosure provides a method for comfortable braking. The method includes determining a comfortable braking force based on an openness of a brake pedal of the vehicle. The method further comprises obtaining a current hydraulic braking force of the vehicle. The method further comprises requesting a drive force from a vehicle control unit in response to the hydraulic braking force being greater than the comfortable braking force. In addition, the method further comprises performing comfortable braking on the vehicle based on the hydraulic braking force and the drive force.

A second aspect of the present disclosure provides a device for comfortable braking. The device includes a comfortable braking determination unit configured to determine a comfortable braking force based on an openness of a brake pedal of a vehicle. The device further comprises a hydraulic brake acquisition unit configured to acquire a current hydraulic braking force of the vehicle. The device further comprises a drive force request unit configured to request a drive force from a vehicle control unit in response to the hydraulic braking force being greater than the comfortable braking force. In addition, the device further comprises a comfortable braking control unit configured to perform comfort braking on the vehicle based on the hydraulic braking force and the drive force.

According to a third aspect of the present disclosure, a controller is provided. The controller comprises at least one processor, and a memory coupled to the at least one processor and having instructions stored thereon that, when executed by the at least one processor, cause the controller to perform the steps of the method of the first aspect of the present disclosure.

According to a fourth aspect of the present disclosure, a computer program product is provided. The computer program product is tangibly stored on a non-transitory computer-readable medium and includes computer-executable instructions that, when executed, cause the computer to perform the steps of the method of the first aspect of the disclosure.

According to a fifth aspect of the present disclosure, a machine-readable storage medium is provided. The machine-readable storage medium has machine-executable instructions stored thereon, wherein the machine-executable instructions are executed by a processor to implement the steps of the method of the first aspect of the present disclosure.

### BRIEF DESCRIPTION OF THE DRAWINGS

The exemplary examples of the present disclosure will be described in further detail in conjunction with accompanying drawings in order to further clarify the above-mentioned and other objectives, features and advantages of the present disclosure, wherein in the exemplary examples of the present disclosure, the same reference number typically represents the same parts.

FIG. 1 shows a schematic diagram of an exemplary environment in which a controller and/or method according to examples of the present disclosure may be implemented;

FIG. 2 shows a flow chart of a method for comfortable braking according to examples of the present disclosure;

FIG. 3A shows a schematic diagram of a process for achieving comfortable braking according to examples of the present disclosure;

FIG. 3B shows a schematic diagram of a change in the braking force in the process of achieving comfortable braking according to examples of the present disclosure.

FIG. 4 shows a schematic diagram of a process for monitoring a drive force according to examples of the present disclosure;

FIG. 5 shows a schematic diagram of a process for achieving comfortable braking according to examples of the present disclosure;

FIG. 6 shows a schematic view of a device for comfortable braking according to examples of the present disclosure;

FIG. 7 shows a schematic block diagram of an exemplary device according to an example that is suitable to embody the content of the present disclosure.

In the various accompanying drawings, the same or corresponding numbers represent the same or corresponding portions.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure.

As previously noted, the comfortable braking plays a very important role in the field of automotive brakes. However, the relevant comfortable braking technology cannot be used with the participation of hydraulic brakes because in the traditional coupled brake system, hydraulic braking forces are not flexibly regulated and therefore cannot effectively support the comfortable braking function. To this end, the examples of the present disclosure provide a scheme for comfortable braking that enables comfortable braking in a braking process by requesting a drive force from a motor during the braking process to flexibly control the summative braking force.

The scheme first determines a comfort braking force based on an openness of a brake pedal stepped down by a driver and obtains a current hydraulic braking force of the vehicle. If the hydraulic braking force is greater than the comfortable braking force, then it requests a drive force from a vehicle control unit and performs comfortable braking on the vehicle based on the hydraulic braking force and the drive force. As such, the scheme according to examples of the present disclosure enables the realization of the comfortable braking function with the participation of hydraulic brakes, which improves the flexibility of the comfortable braking by simultaneously utilizing the hydraulic braking force and the drive force for comfortable braking, and expands the application scene of the comfortable braking, thereby improving the ride experience of drivers and passengers.

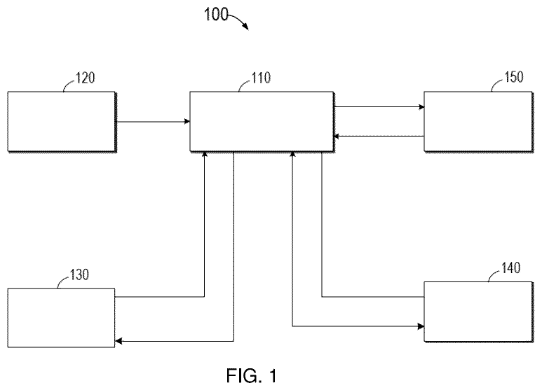

Examples of the present disclosure will be described in further detail below in conjunction with the accompanying drawings, wherein FIG. 1 illustrates an exemplary environment 100 in which the controller and/or method according to the examples of the present disclosure may be implemented.

As shown in FIG. 1, the exemplary environment 100 includes a control system 110. The control system 110 may receive a comfortable braking activation flag, a magnitude of the comfortable braking force, and a gradient value from a comfortable braking module 120. The comfortable braking activation flag is used to inform the control system 110 whether to enable the comfortable braking function. When the comfortable braking activation flag is received, the control system 110 activates a corresponding control strategy. The magnitude of the comfortable braking force is a target value of the comfortable braking force calculated by the comfortable braking module 120 based on the current vehicle state. By receiving the magnitude information of the braking force, the control system 110 can adjust the drive force to achieve comfortable braking. A gradient value is the grade information of the vehicle at its current location. In some embodiments, a gradient value may be obtained from a grade sensor for the location where the vehicle is currently located. In some embodiments, the vehicle may not include a grade sensor, but the gradient value may be estimated from other sensor information to generate a slope estimate. In some embodiments, when the vehicle is in a ramp, the desired braking force and the comfortable braking force change, and the comfortable braking module 120 may utilize parameters of a gradient value or a slope estimate when determining the comfortable braking force. In some embodiments, it is possible to determine the target braking force desired by the driver by the openness of the brake pedal, and then determine the comfortable braking force according to the parameters of the target braking force, vehicle speed, decelerating speed, and gradient value. Further, in some embodiments, the control system 110 may determine a comfortable braking force based on the openness of the brake pedal.

The control system 110 may request a regenerative braking force from a regenerative braking module 130. Regenerative braking is a braking technique used in electric vehicles that converts and stores the kinetic energy of the vehicle during braking. In particular, the regenerative braking switches an electric motor to an electric generator in the condition of braking, utilizing the inertial force of the vehicle to cause the motor rotor to rotate, thereby creating a reverse torque for braking. When the brake pedal is not pressed down, the energy recovery by the accelerated pedal alone is called slip energy recovery. The working condition of the slip energy recovery (also referred to as sliding energy recovery) is that the vehicle has a certain speed. After the driver releases the accelerated pedal, the motor changes from providing drive torque to feedback braking torque, thereby generating regenerative braking force and generating braking deceleration on the entire vehicle. The working condition of the braking regeneration (braking energy recovery) is that when the brake pedal is pressed down, the motor provides braking torque to generate a regenerative braking force. In some embodiments, the control system 110 may request the regenerative braking force from the regenerative braking module 130, and the regenerative braking unit 130 may send the magnitude of the actual regenerative braking force that may be provided to the control system 110. The actual regenerative braking force that may be provided by the regenerative braking module 130 is related to the recovery power, battery charge, current vehicle speed, and other parameters of the motor.

With continued reference to FIG. 1, the control system 110 may also interact with a hydraulic braking module 140. For example, the control system 110 may request a hydraulic braking force from the hydraulic braking module 140. The hydraulic braking force refers to the force of the brake pedal converted by a hydraulic device in an automotive braking system to the force of a brake. The magnitude of the hydraulic braking force usually depends on the force of the brake pedal, the pressure of a total brake pump, the performance of a brake liquid, the resistance of a brake oil pipe, the efficiency of a brake pump, the structure of the brake and the friction coefficient, etc. The hydraulic braking force is a braking force mode commonly used in current automotive braking systems. It can be combined with electronic control systems such as ABS, EBD, and ESP to improve the braking performance and safety of automobiles. In a comfortable braking scene, the driver often does not actively release the brake pedal, resulting in the brake fluid not being able to return from the brake wheel cylinder to the brake master cylinder, so the hydraulic braking force cannot be reduced and it is not easy to be adjusted to achieve comfortable braking.

The hydraulic braking module 140 may send the magnitude of the current hydraulic braking force to the control system 110. For example, the control system 110 may request a hydraulic braking force of 500 N from the hydraulic braking module 140. However, the hydraulic braking module 140 may send to the control system 110 a current hydraulic braking force of 800 N. As previously described, the hydraulic braking force actually provided by the hydraulic braking module 140 is at least 800 N. In addition, the control system 110 may also request a compensation braking force from the hydraulic braking module 140. For example, when it is detected that the magnitude of the current regenerative braking force does not meet the requirements for safety, a hydraulic braking force may be requested from the hydraulic braking module 140 to compensate for the braking force.

With continued reference to FIG. 1, the control system 110 may also interact with a vehicle control unit 150. For example, the control system 110 may request a drive force from the vehicle control unit 150. For example, the vehicle control unit 150 may acquire a drive force from the motor. The motor drive force in a vehicle refers to the force that a motor converts electrical energy into mechanical energy to drive the wheels. The motor drive force is related to the motor type, power, efficiency, control mode, transmission ratio, etc. Further, the vehicle control unit 150 may send an actual drive force that may be provided to the control system 110. For example, the actual drive force that the motor may provide may be smaller than the drive force requested by the control system 110 due to factors such as vehicle speed, battery level, and motor abnormality.

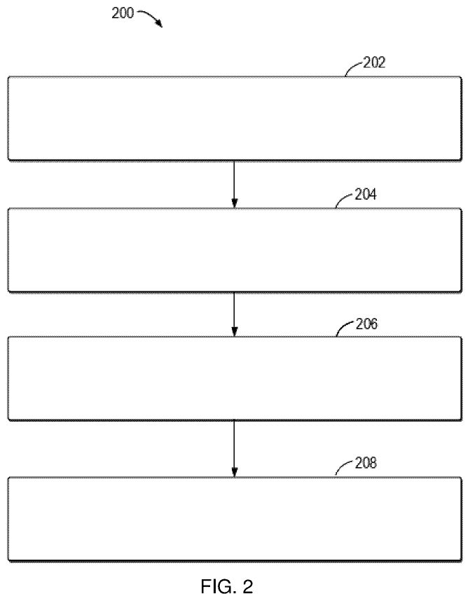

The above, in conjunction with FIG. 1, describes an exemplary environment 100 in which the examples of the present disclosure may be implemented. A flowchart of a method 200 for comfortable braking according to examples of the present disclosure will be described below in connection with FIG. 2.

FIG. 2 shows a flowchart of the method 200 for comfortable braking, consistent with examples of the present disclosure. At block 202, a comfortable braking force may be determined based on the openness of the brake pedal of the vehicle. For example, in connection with FIG. 1, the control system 110 may determine a comfortable braking force based on the openness of the brake pedal of the vehicle. Openness refers to the depth of the brake pedal, i.c., the degree to which the driver steps down the brake pedal. For example, if there is a large openness, the system may choose not to trigger comfortable braking, but rather to provide a target braking force that matches the driver's needs to accommodate more urgent braking demands. At block 204, a current hydraulic braking force of the vehicle may be obtained. For example, in connection with FIG. 1, the control system 110 may acquire a current hydraulic braking force of the vehicle. The current hydraulic braking force is the actual magnitude of the braking force applied by the hydraulic braking system to the vehicle, and the control system 110 may acquire the current hydraulic braking force from the hydraulic braking module 140.

At block 206, the drive force may be requested from the vehicle control unit in response to the hydraulic braking force being greater than the comfortable braking force. For example, in connection with FIG. 1, the control system 110 may request a drive force from the vehicle control unit 150 in response to the hydraulic braking force being greater than the comfortable braking force. At block 208, the vehicle may be subjected to comfortable braking based on the hydraulic braking force and drive force. For example, in connection with FIG. 1, the control system 110 may perform comfortable braking on the vehicle based on the hydraulic braking force and drive forces.

As such, the method 200 according to an embodiment of the present disclosure enables the realization of the comfortable braking function with the participation of hydraulic brakes, which improves the flexibility of the comfortable braking by simultaneously utilizing the hydraulic braking force and the drive force, and expands the application scene of the comfortable braking, thereby improving the ride experience of drivers and passengers.

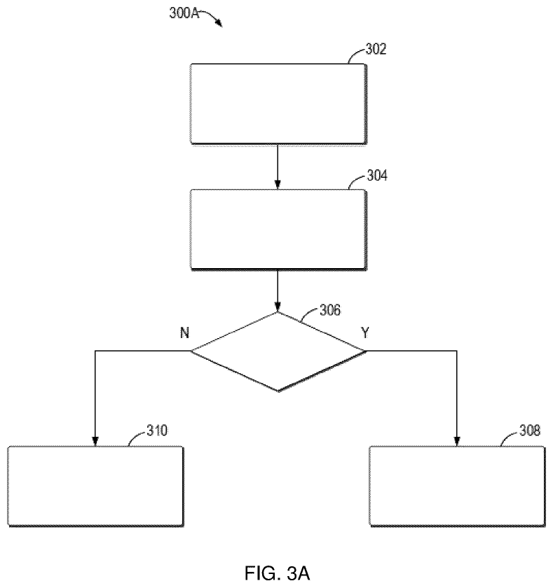

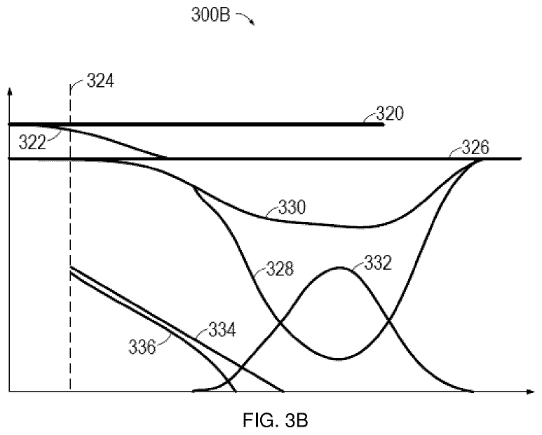

FIG. 3A shows a schematic diagram of a process 300A for achieving comfortable braking, and FIG. 3B shows a schematic diagram 300B of a change in the braking force in the process of achieving comfortable braking, consistent with examples of the present disclosure. The process of comfortable braking according to examples of the present disclosure will be described below in conjunction with FIGS. 3A and 3B.

As shown in FIG. 3A, at block 302, a comfortable braking force may be determined. For example, the magnitude of deceleration of the vehicle may be obtained from an acceleration sensor and a speed sensor, the openness of the brake pedal is obtained from a brake pedal sensor, the speed of the vehicle is obtained from the speed sensor, and the gradient value or slope estimate of the vehicle is obtained from a grade sensor, and the magnitude of the comfortable braking force is calculated from these parameters. In some embodiments, parameters such as entire vehicle mass, wheel rolling radius, and front and rear axle wheel distance may also be utilized to calculate the comfortable braking force. In some embodiments, machine learning and/or a deep learning model may be utilized to process parameters of the vehicle to calculate the comfortable braking force.

At block 304, a current hydraulic braking force may be obtained. For example, the current hydraulic braking force may be obtained from the hydraulic braking module 140 in connection with FIG. 1. As previously noted, in a coupled brake system, the brake system cannot lower the hydraulic braking force when the driver maintains the openness of the brake pedal, and therefore it is necessary to determine the current hydraulic braking force to determine a minimum hydraulic braking force actually provided.

At block 306, it may be compared whether the current hydraulic braking force is greater than the comfortable braking force. For example, by comparing the current hydraulic braking force and the comfortable braking force, it can be determined if a drive force is required to achieve comfortable braking or if a regenerative braking force is required to achieve comfortable braking. If the current hydraulic braking force is greater than the comfortable braking force, then proceed to block 308. At block 308, a drive force may be requested to offset the hydraulic braking force to achieve comfortable braking. For example, when the current hydraulic braking force is 800 N and the comfortable braking force is 500 N, a drive force of 300 N may be requested from the vehicle control unit to offset the additional hydraulic braking force. In some implementations, the hydraulic braking force may be offset with a drive force based on the comfortable braking force. In some embodiments, the vehicle may be subjected to comfortable braking using an offset hydraulic braking force.

The braking force change in the process of achieving comfortable braking is described below in connection with FIG. 3B. As shown in FIG. 3B, the straight line 320 represents a slip regeneration request. The slip regeneration is part of regenerative braking, and when the driver releases the acceleration pedal and does not step down the brake pedal, the slip regeneration request is triggered. The curve 322 represents a regenerative braking force corresponding to the slip regeneration request. The dashed line 324 represents the start of the comfortable braking and it can be seen that with the intervention of the comfortable braking, the curve 322 gradually exits, i.c., the regenerative braking force corresponding to the slip regeneration request slowly changes to zero. The straight line 326 represents the target braking force requested by the driver and the curve 328 represents the comfortable braking force. It can be seen that the comfortable braking force is less than the target braking force, thereby reducing the impact in the braking process and achieving the comfortable braking process. Further, the curve 330 represents an actual hydraulic braking force and the curve 332 represents a drive force requested from the vehicle control unit. As can be seen, as described in block 308 in FIG. 3A, the actual hydraulic braking force may be offset by the drive force such that the actual generated braking force is consistent with the comfortable braking force curve 328. In some embodiments, the drive force may be lowered to zero in response to the vehicle stopping. In some embodiments, the hydraulic braking force may be increased to equal to the target braking force in response to the vehicle stopping.

With continued reference to FIG. 3A, if the current hydraulic braking force is less than the comfortable braking force at block 306, then proceed to block 310. At block 310, a regenerative braking force may be requested for compensation to achieve comfortable braking. In some embodiments, the regenerative braking force may be requested in response to the hydraulic braking force being less than the comfortable braking force. For example, when the current hydraulic braking force is 400 N and the comfortable braking force is 500 N, a regenerative braking force of 100 N may be requested from the regenerative braking module for compensation. In some embodiments, a hydraulic braking force may also be requested for compensation. For example, when the current hydraulic braking force is 400 N and the comfortable braking force is 500 N, a hydraulic braking force of 100 N may be requested from the hydraulic braking module for compensation. In some embodiments, the vehicle may be subjected to comfortable braking based on the hydraulic braking force and the regenerative braking force. In combination with FIG. 3B, where the slash 334 represents a regenerative braking intervention, the curve 336 represents a regenerative braking force corresponding to the regenerative braking intervention, and the regenerative braking force requested by the regenerative braking module may be used to compensate for the hydraulic braking force.

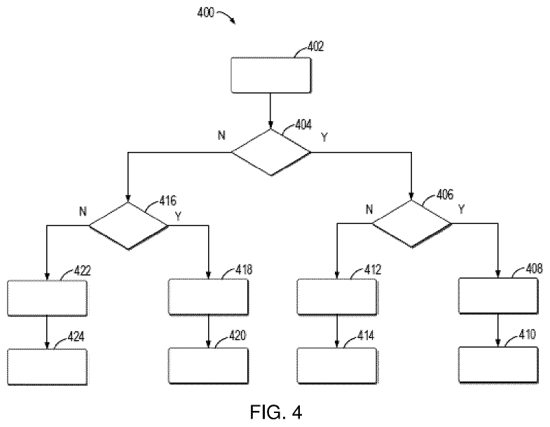

FIG. 4 shows a schematic view of a process 400 for monitoring a drive force, consistent with examples of the present disclosure. At block 402, the actual drive force of the vehicle may be monitored. For example, in connection with FIG. 1, the control system 110 may acquire a current drive force of the vehicle from the vehicle control unit 150. In some embodiments, the actual drive force of the vehicle may be obtained. At block 404, it may be determined whether a summative braking force after the hydraulic braking force is offset by the drive force is greater than the comfortable braking force. For example, assuming a drive force of 100 N is requested from the vehicle control unit and a hydraulic braking force of 500 N is requested from the hydraulic control module, the summative braking force is 400 N and the summative braking force and the comfortable braking force may be compared to determine the magnitude. In some embodiments, the summative braking force may be determined based on the actual drive force and the hydraulic braking force. If the summative braking force is greater than the comfortable braking force, proceed to block 406. At block 406, it may be determined whether the summative braking force is less than the target braking force. For example, the driver's desired target braking force may be determined by the openness of the brake pedal.

If the summative braking force is less than the target braking force, proceed to block 408. At block 408, the drive force is further requested to align the summative braking force with the comfortable braking force curve. For example, when the summative braking force is 400 N, the target braking force is 800 N, and the comfortable braking force is 300 N, an additional 100 N drive force may be requested to reduce the summative braking force to 300 N. At block 410, an additional target drive force may be sent to the vehicle control unit. Returning to block 406, if the summative braking force is not less than the target braking force, then proceed to block 412. At block 412, the comfortable braking is not activated. For example, when the summative braking force is 800 N and the target braking force is 800 N, and the comfortable braking is not activated, the impact generated by the brake to cause the vehicle to stop is relatively large. Therefore, a drive force may be requested from the vehicle control unit to reduce the summative braking force, trigger the comfortable braking, and improve the comfort of braking. In some embodiments, the hydraulic braking force and the drive force may be adjusted based on the summative braking force, the comfortable braking force, and the requested target braking force. In some embodiments, the drive force may be increased in response to the summative braking force being equal to the target braking force, thereby reducing the summative braking force. At block 414, an indicator may be sent to the vehicle control unit to indicate an activation state of the comfortable braking and a request for the drive force.

Returning to block 404, if the summative braking force is not greater than the comfortable braking force, proceed to block 416. At block 416, it may be determined whether the summative braking force is equal to the comfortable braking force. If the summative braking force is equal to the comfortable braking force, then proceed to block 418. At block 418, comfortable braking with full performance may be triggered. For example, when the summative braking force and the comfortable braking force are both 500 N, comfortable braking with full performance may be triggered. At block 420, a comfortable braking indicator may be sent to the vehicle control unit. For example, real-time feedback on the performance of the comfortable braking ensures that the driver is aware of the braking performance of the vehicle and allows other systems to make adjustment based on the performance level of the comfortable braking.

Returning to block 416, if the summative braking force is less than the comfortable braking force, proceed to block 422. At block 422, the requested drive force may be reduced or an additional hydraulic braking force may be requested to compensate for the summative braking force. For example, if the comfortable braking force is 500 N and the summative braking force is 400 N, there may be a security risk and therefore an instruction to reduce 100 N of the requested drive force needs to be sent to the vehicle control unit, or an additional 100 N of hydraulic braking force be requested from the hydraulic braking module to assist braking. At block 424, instructions of reducing the requested drive force, and an indicator to indicate that a security risk may be present may be sent to the vehicle control unit. In some embodiments, the requested drive force may be reduced or the hydraulic braking force may be increased in response to the summative braking force being less than the comfortable braking force.

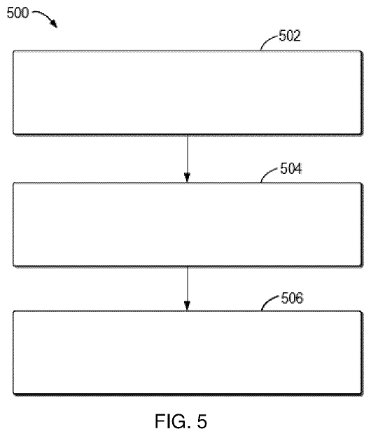

FIG. 5 shows a schematic view of a process 500 for implementing comfortable braking, consistent with examples of the present disclosure. At block 502, the drive force may be requested from the front axle motor and the front axle summative braking force may be determined. The front axle motor and the rear axle motor refer to the manner in which the motors in the vehicle are arranged on the front axle and the rear axle respectively, which can achieve four-wheel drive, increasing the traction and maneuverability of the vehicle. The front axle motor and the rear axle motor can automatically adjust the output power and torque of the motor according to different working conditions and driving modes. In the comfortable braking in the later stages of braking, the speed of the vehicle is very low due to the proximity to parking, and the front and rear axle regenerative braking forces of the vehicle are redundant. At this time, the front axle regenerative braking force can be transferred completely to the rear axle braking force, so a drive force can be requested from the front axle motor to reduce the front axle summative braking force. In some embodiments, the front axle summative braking force may be determined by the drive force and the hydraulic braking force on the front axle.

At block 504, a regenerative braking force may be requested from the rear axle motor and the rear axle summative braking force may be determined. For example, in order to increase the braking force of the rear axle, a regenerative braking force may be requested from the rear axle motor. In some embodiments, the rear axle summative braking force may be determined by the regenerative braking force and the hydraulic braking force on the rear axle. In some embodiments, the front axle summative braking force and rear axle summative braking force may be distributed based on a predetermined scale or may be dynamically distributed based on vehicle status. At block 506, the vehicle may be subjected to comfortable braking based on the front axle summative braking force and the rear axle summative braking force.

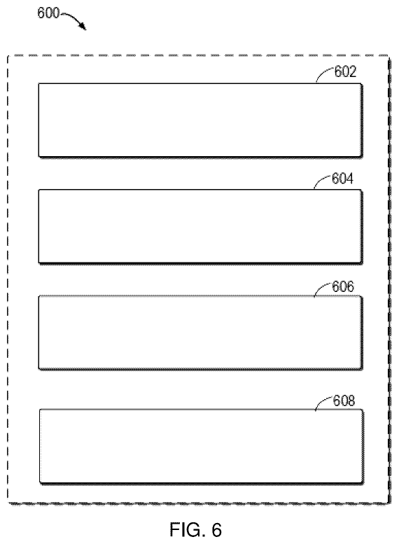

FIG. 6 shows a schematic view of a device 600 for comfortable braking, consistent with examples of the present disclosure. The device 600 includes a comfortable braking determination unit 602 configured to determine a comfortable braking force based on an openness of a brake pedal of a vehicle. The device 600 also includes a hydraulic brake acquisition unit 604 configured to acquire a current hydraulic braking force of the vehicle. The device 600 also includes a drive force request unit 606 configured to request a drive force from a vehicle control unit in response to the hydraulic braking force being greater than the comfortable braking force. In addition, the device 600 further includes a comfortable braking control unit 608 configured to perform comfortable braking on the vehicle based on the hydraulic braking force and the drive force.

In some embodiments, the comfortable braking control unit 608 comprises: a drive force canceling unit configured to offset the hydraulic braking force with the drive force based on the comfortable braking force; and a comfortable braking second control unit using the offset hydraulic braking force to perform the comfortable braking on the vehicle.

In some examples, the device 600 further comprises: an actual drive acquisition unit, configured to acquire an actual drive force of the vehicle; a summative braking determination unit, configured to determine a summative braking force based on the actual drive force and the hydraulic braking force; a braking force adjustment unit, configured to adjust the hydraulic braking force and the drive force based on the summative braking force, the comfortable braking force, and the requested target braking force.

In some embodiments, the braking force adjustment unit comprises: a hydraulic braking increasing unit configured to increase the hydraulic braking force or decrease the drive force in response to the summative braking force being less than the comfortable braking force; and a drive force adjustment unit configured to increase the drive force in response to the summative braking force being greater than the comfortable braking force.

In some embodiments, the braking force adjustment unit further comprises: a comfortable braking trigger unit configured to trigger comfortable braking with full performance in response to the summative braking force being equal to the comfortable braking force.

In some examples, the device 600 further comprises: a regenerative braking request unit configured to request a regenerative braking force in response to the hydraulic braking force being less than the comfortable braking force; and a comfortable braking third control unit configured to perform comfortable braking on the vehicle based on the hydraulic braking force and the regenerative braking force.

In some examples, the device 600 further comprises: a front axle braking determination unit configured to determine a front axle summative braking force based on the hydraulic braking force and a drive force requested from a front axle motor of the vehicle; a rear axle braking determination unit configured to determine a rear axle summative braking force based on the hydraulic braking force and a regenerative braking force requested from a rear axle motor of the vehicle; and a comfortable braking fourth control unit configured to perform comfortable braking on the vehicle based on the front axle summative braking force and the rear axle summative braking force.

In some embodiments, the comfortable braking determination unit 602 comprises: a target braking determination unit configured to determine a requested target braking force based on the openness of the brake pedal; and a comfortable braking second determination unit configured to determine the comfortable braking force based on the target braking force, a gradient value of the vehicle and a vehicle speed of the vehicle.

In some examples, the device 600 further comprises: a drive force adjustment unit configured to reduce the drive force to zero or transition to an idle drive force of the vehicle in response to the vehicle stopping; and a hydraulic braking adjustment unit configured to increase the hydraulic braking force to equal to the target braking force.

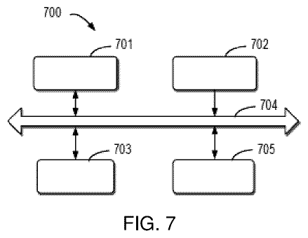

FIG. 7 shows a schematic block diagram of an example apparatus 700 that can be used to implement examples of the present disclosure. As shown in the drawing, the apparatus 700 includes a processor 701, which can perform various appropriate actions and processes according to embedded program instructions stored in a read-only memory (ROM) 702 or embedded program instructions in a random-access memory (RAM) 703. Various programs and data required for the operation of the apparatus 700 can also be stored in the RAM 703. The processor 701, the ROM 702, and the RAM 703 are interconnected through a bus 704. An input/output (I/O) interface 705 is also connected to the bus 704.

The various processes and processing described above may be executed by the processor 701. For example, in some examples, it can be implemented as an embedded program tangibly contained in a machine-readable medium. In some examples, a part or all of the embedded programs may be loaded and/or installed onto the apparatus 700 via the ROM 702. When the embedded program is loaded onto the RAM 703 and executed by the processor 701, one or more actions of the method and process described in the present disclosure may be performed.

The machine-readable storage medium may be a tangible device that maintains and stores instructions used to instruct execution devices. The machine-readable storage medium, for example, may be-but is not limited to-an electrical storage device, magnetic storage device, optical storage device, electromagnetic storage device, semiconductor memory device, or any suitable combination of the above. More specific examples of the machine-readable storage medium (a non-exhaustive list) comprise: random access memory (RAM), read-only memory (ROM), wipeable programmable read-only memory (EPROM or flash memory), static random access memory (SRAM), and any suitable combination of the above. The machine-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The machine-readable program instructions described herein may be downloaded to various computing/processing devices from machine-readable storage medium, or downloaded from networks, such as the Internet, a local area network, a wide-area network and/or a wireless network to external machines or external storage devices. The networks may comprise copper transmission cables, optical fiber transmissions, wireless transmissions, routers, firewalls, switches, gateway machines, and/or edge servers. The network adapter card or network interface in each computing/processing device receives the machine-readable program instructions from the network and forwards the machine-readable program instructions for storage in machine-readable storage medium of each computing/processing device.

The machine program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. Machine-readable program instructions may be fully executed on the user's machine, partially executed on the user's machine, executed as an independent software package, partially executed on the user's machine and partially executed on a remote machine, or fully executed on a remote machine or server. Where a remote machine is involved, the remote machine may be connected to the user's machine through any type of network, including local area network (LAN) or wide area network (WAN), or it may be connected to an external machine (such as by using an Internet service provider for Internet connection). In some examples, the state information of machine-readable program instructions is used to personalize custom electronic circuits, such as a programmable logic circuit, field-programmable gate array (FPGA) or programmable logic array (PLA), wherein the electronic circuit is able to execute machine-readable program instructions, thereby achieving the various aspects of the present disclosure.

Various aspects of the present disclosure are described herein with reference to flow charts and/or block diagrams depicting methods, apparatus (systems), and computer program products according to the examples of the present disclosure. It should be understood that every block in the flow charts and/or block diagrams and the combinations of various blocks in the flow charts and/or block diagrams may be implemented by machine-readable program instructions.

These machine-readable program instructions may be provided to general-purpose machines, dedicated machines or the processing units of other programmable data processing devices, thereby producing a type of machine, such that when these instructions are executed by the machines or processing units of other programmable data processing devices, an apparatus that realizes the functions/actions stipulated in one or more boxes in the flow charts and/or block diagrams is produced. These machine-readable program instructions may also be stored in machine-readable storage medium, enabling machines, programmable data processing devices, and/or other devices to operate in a specific manner. Therefore, the machine-readable media containing instructions comprise a manufactured product that includes instructions for implementing various aspects of the functions/actions specified in one or more boxes in the flow charts and/or block diagrams.

The machine-readable program instructions may also be loaded onto a machine, other programmable data processing devices, or other devices, enabling a series of operational steps to be executed on the machine, other programmable data processing devices, or other devices to generate a machine-implemented process. This enables the instructions executed on the machine, other programmable data processing devices, or other devices to implement the functions/actions specified in one or more boxes in the flow charts and/or block diagrams.

The flow charts and block diagrams in the accompanying drawings show the system architecture, functions and operations that may be implemented based on the systems, methods and computer program products according to the plurality of examples of the present disclosure. Regarding this, every block in the flow chart or block diagram can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and machine instructions. The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used in this text aims to best explain the principles and actual application of the various examples, the technological improvements in the technology in the market, or allow others of ordinary skill in the art to understand the various examples disclosed in this text.

What is claimed is:

1. A method for comfortable braking, comprising:
determining a comfortable braking force based on an openness of a brake pedal of a vehicle;
acquiring a current hydraulic braking force of the vehicle;
requesting a drive force from a vehicle control unit in response to the hydraulic braking force being greater than the comfortable braking force; and
performing comfortable braking on the vehicle based on the hydraulic braking force and the drive force.

2. The method according to claim 1, wherein performing the comfortable braking on the vehicle comprises:
offsetting the hydraulic braking force with the drive force based on the comfortable braking force; and
using the offset hydraulic braking force to perform the comfortable braking on the vehicle.

3. The method according to claim 1, further comprising:
obtaining an actual drive force of the vehicle;
determining a summative braking force based on the actual drive force and the hydraulic braking force; and
adjusting the hydraulic braking force and the drive force based on the summative braking force, the comfortable braking force, and the requested target braking force.

4. The method according to claim 3, wherein adjusting the hydraulic braking force and the drive force comprises:
increasing the hydraulic braking force or decreasing the drive force in response to the summative braking force being less than the comfortable braking force; and
increasing the drive force in response to the summative braking force being greater than the comfortable braking force.

5. The method according to claim 4, further comprising:
in response to the summative braking force being equal to the comfortable braking force, triggering comfortable braking with full performance.

6. The method according to claim 1, further comprising:
requesting a regenerative braking force in response to the hydraulic braking force being less than the comfortable braking force; and
performing comfortable braking on the vehicle based on the hydraulic braking force and the regenerative braking force.

7. The method according to claim 6, further comprising:
determining a front axle summative braking force based on the hydraulic braking force and a drive force requested from a front axle motor of the vehicle;
determining a rear axle summative braking force based on the hydraulic braking force and a regenerative braking force requested from the rear axle motor of the vehicle; and
performing comfortable braking on the vehicle based on the front axle summative braking force and the rear axle summative braking force.

8. The method according to claim 1, wherein determining the comfortable braking force comprises:
determining a requested target braking force based on the openness of the brake pedal; and
determining the comfortable braking force based on the target braking force, a gradient value of the vehicle, and a vehicle speed of the vehicle.

9. The method according to claim 8, further comprising:
reducing the drive force to zero in response to the vehicle stopping; and
increasing the hydraulic braking force equal to the target braking force.

10. The method according to claim 8, further comprising:
transitioning the drive force to an idle drive force of the vehicle in response to the vehicle stopping; and
increasing the hydraulic braking force equal to the target braking force.

11. A device for comfortable braking, comprising:
a comfortable braking determination unit configured to determine a comfortable braking force based on an openness of a brake pedal of a vehicle;
a hydraulic brake acquisition unit configured to acquire a current hydraulic braking force of the vehicle;
a drive force request unit configured to request a drive force from a vehicle control unit in response to the hydraulic braking force being greater than the comfortable braking force; and
a comfortable braking control unit configured to perform comfortable braking on the vehicle based on the hydraulic braking force and the drive force.

12. A controller, comprising:
at least one processor, and
a memory, coupled to the at least one processor, and having instructions stored thereon that, when executed by the at least one processor, cause the controller to perform the method according to claim 1.

13. A computer program product that is tangibly stored on a non-transitory computer-readable medium and includes machine-executable instructions that are used to execute the method according to claim 1.
